(19) United States
(12) Patent Application Publication
(10) Pub. No.: US 2003/0216975 A1
(43) Pub. Date: Nov. 20, 2003

(54) Method and system for managing inventory in a supply chain

(76) Inventors: Paul D. Montey, Femdale, MI (US); David George Ramsey, Sterling Heights, MI (US); John Hindinger, Dearborn, MI (US); Michael K. O'Connor, W. Bloomfield, MI (US); Robyn P. Weems, Farmington Hills, MI (US); Vince Aquinto, Ann Arbor, MI (US)

Correspondence Address: BROOKS & KUSHMAN P.C./FGTL, 1000 TOWN CENTER, 22ND FLOOR, SOUTHFIELD, MI, 48075-1238, US

(21) Appl. No.: 10/305,219

(22) Filed: Nov. 26, 2002

Related U.S. Application Data
(60) Provisional application No. 60/333,693, filed on Nov. 26, 2001.

(51) Int. Cl. G06F 17/60

(52) U.S. Cl. 705/28

(57) ABSTRACT

Computer-implemented method and system enables suppliers to manage real-time manufacturer inventory levels. A client-server (e.g., Internet-based) architecture communicates with at least one inventory database. Supplier/user input defines a supplier and manufacturer plant to which the supplier supplies goods. A listing of goods the supplier supplies to the manufacturer plant is displayed at the client computer. For goods listed, the current manufacturer balance-on-hand for that good, the number of days before the manufacturer balance-on-hand will be depleted, and an indicator if the current manufacturer balance-on-hand is below a predefined level is also displayed. The user/supplier inputs a promise to supply one or more goods having a current manufacturer balance-on-hand below the predefined level (e.g., low, critical, etc.). Another indicator indicates whether supplier shipped and in-transit quantities for the good reconcile with manufacturer received quantity for the good. A user/supplier may challenge the posted manufacturer received quantity for the good.

### CROSS-REFERENCE TO RELATED APPLICATIONS

This application is a claims the benefit of U.S. provisional application Serial No. 60/333,693, filed Nov. 26, 2001.

### BACKGROUND OF THE INVENTION

1. Field of the Invention

The present invention relates generally to computer systems and methodologies supporting supply chain activities and communications and, more particularly, to a method and system for managing manufacturer inventory levels in a supply chain.

2. Background Art

Prior supply base-driven inventory management methods and systems fail to take full advantage of supplier participation in manufacturer inventory control. For example, one prior system tracks conventional purchasing methodologies in which the purchaser/manufacturer determines which seller/supplier to purchase from. To be effective, this particular system relies upon complex integrated information technology and comparative pricing logic for making purchase decisions. To the contrary, the present invention enables suppliers to make supply decisions themselves based upon real-time manufacturer inventory information (e.g., days balance on hand data).

Another vendor-driven inventory architecture known as “Just-In-Time” (JIT) ultimately relies upon the purchaser (e.g., manufacturer) to initiate a purchase order or requisition for goods—orally, electronically or otherwise.

One disadvantage of these and other arrangements is the time and effort expended at the purchaser/manufacturer location to (i) recognize that inventory for a particular supplied good is low, critically low or depleted, and (ii) pro-actively initiate replenishment in an efficient manner that prevents an over or under-supply of a particular good at the manufacturer location. Embodiments of the present invention enable the supply base to efficiently and effectively assume these responsibilities in a novel and efficient manner.

### SUMMARY OF THE INVENTION

One embodiment of the present invention includes an intuitive, easy-to-use web front-end for managing manufacturer inventory within a supply base. Utilizing the present invention, a supply base may view and update relevant manufacturer inventory information, as well as efficiently manage inventory levels for the manufacturer. The present invention presents inventory-related data and inventory management functionality to the supply base and internal application users in a real-time format. A preferred system embodiment utilizes DB2 tables providing a real-time, stable, scalable and flexible data environment.

One advantage of the present invention is a reduction in connectivity costs between a manufacturer and its supply base. A web-based open system architecture enables suppliers anywhere to access and process real-time manufacturer inventory data at any time. These advantages reduce conventional maintenance and improvement costs, reduce the cost of dedicated or proprietary connectivity between the manufacturer and its supply base, and utilizes more user-friendly point and click navigation as opposed to conventional keyboard commands associated with green-screen mainframe legacy systems. The flexible nature of this arrangement enables system modifications more quickly and easily, particularly in response to changing business conditions.

A reconciliation feature associated with one embodiment of the present invention facilitates a communication process between a supplier and a manufacturing plant such that cumulative ship and receipt records can be reconciled. A goal of this aspect of the present invention is to confirm that a supplier's cumulative ship records are in agreement with the cumulative receipt and in-transit records at their customer plants.

Other objectives of the present invention include improving supplier accessibility and utility of timely and accurate inventory/manufacturing information and minimizing the cost of training suppliers to perform inventory-related management functions.

Embodiments of the present invention include a computer-implemented method and system enabling suppliers to monitor and manage real-time manufacturer inventory levels for supplied goods. Embodiments may be implemented in a client-server (e.g., Internet-based) architecture in operable communication with at least one database of real-time manufacturer inventory information for supplied goods.

In a client-server arrangement, embodiments include receiving input at a client computer defining a supplier and a manufacturer plant to which the supplier supplies goods, displaying at the client computer a listing of one or more goods the supplier supplies to the manufacturer plant and, for each good listed, the current manufacturer balance-on-hand for that good, the number of days before the manufacturer balance-on-hand will be depleted, and an indicator if the current manufacturer balance-on-hand is below a certain level, and receiving input at the client computer defining a promise to supply one or more goods having a current manufacturer balance-on-hand below the certain level. In this manner, suppliers may submit a promise to supply a particular good without receiving a prompt or other manufacturer request (e.g., purchase order, requisition, etc.) to do so.

Embodiments may additionally include displaying an indicator at the client computer indicating any listed goods that have a manufacturer balance-on-hand level below a critical level. Another indicator may be provided for indicating whether supplier shipped and in-transit quantities for the good reconcile with manufacturer received quantities for the good. A user/supplier may present input at the client computer challenging the manufacturer received quantities for the good.

Other aspects of the present invention may include a bulletin board displayed at the client computer for communicating one or more manufacturer messages to the supplier. A transaction register may also be displayed including historical inventory transaction information for a specified good.

Suppliers may input packaging specification information for goods the suppliers supply to the manufacturer plant. The packaging specification information may include an indication as to whether a shipment has been confirmed by the supplier.

These and other embodiments of the present invention support other advantages and features such as those described in the detailed description of the preferred embodiments and claims, and as illustrated in the accompanying drawings.

### BRIEF DESCRIPTION OF THE DRAWINGS

FIG. 1 is a context diagram illustrating a supplier's preferred methodology for utilizing various aspects of the present invention;

FIG. 2 illustrates an example “homepage” GUI 46 in accordance with a preferred embodiment of the present invention;

FIG. 3 illustrates an example “shortage parts” GUI 68 in accordance with a preferred embodiment of the present invention;

FIG. 4 illustrates an example “inventory” GUI 80 in accordance with a preferred embodiment of the present invention;

FIG. 5 illustrates an example “promises/remarks” GUI 106 in accordance with a preferred embodiment of the present invention;

FIG. 6 illustrates an example “Reconciliation” GUI 130 in accordance with a preferred embodiment of the present invention;

FIG. 7 illustrates an example “Packaging Specification” GUI 138 in accordance with a preferred embodiment of the present invention; and

FIG. 8 illustrates an example computer system architecture 152 for implementing aspects of the present invention.

### DETAILED DESCRIPTION OF THE PREFERRED EMBODIMENTS

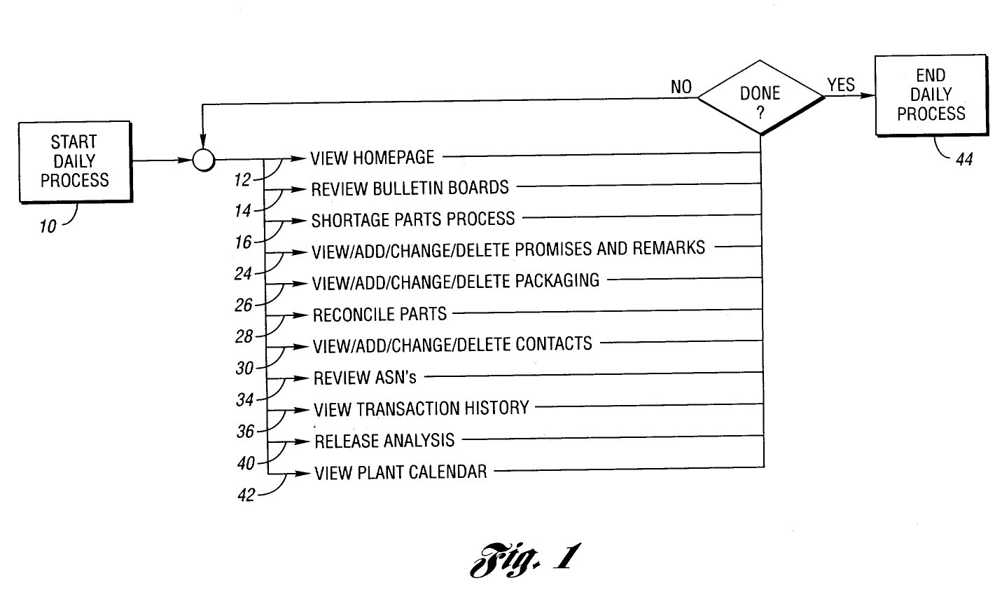

FIG. 1 is a context diagram illustrating a supplier's preferred methodology for utilizing various aspects of the present invention. Notably, the content and arrangement of FIG. 1 may be modified, supplemented or rearranged to best fit a particular implementation of the present invention. Various example graphical user interfaces illustrating functionality described with regard to FIG. 1 are illustrated and described in greater detail below. A supplier's daily process begins at block 10. Arrow items numbered 12 through 42 represent functionality available to supply base users in accordance with a preferred embodiment of the present invention. The home page represented by arrow 12 may be implemented as a graphical user interface summarizing information including but not limited to part shortage, reconciliation, packaging and launch parts information. In addition, the home page may include bulletin board items to particular suppliers, groups of suppliers or the entire supply base. Summary information is provided at the home page to highlight certain aspects of inventory management that require action, such as answering critical part shortages, cumulative parts quantities, disagreements, parts without packaging and launch requirements that have not been promised. The home page facilitates a broad view of this and other related information and may be utilized to prompt action in certain required areas by navigating to additional pages by selecting relevant hyperlinks. An example home page is illustrated and described in greater detail below.

As represented by arrow 14, the user preferably follows the home page view with a review of an online bulletin board as represented by arrow 14. The bulletin board may include manufacturer messages intended for particular suppliers, supplier groups, or the entire supply base. There is no limit to the type of information that may be described. Preferably, the bulletin board displays provides hyperlinks to information including, but not limited to, system maintenance information, plant and supplier-specific messages, corporate information bulletins, delivery order information, warehousing communications, assembly engineering change information, manufacturing planning bulletins, security bulletins, management notices, etc. An example GUI containing a bulletin board in accordance with the present invention is illustrated and described in greater detail below.

As represented by arrow 16, a user is additionally provided with functionality for reviewing real-time inventory status for parts or goods (may include raw materials) that a supplier has promised to-the manufacturer. The term “parts” will generally be used hereafter. In one embodiment, the user is presented with functionality for defining ranges for balance on hand days low and high before inventory will be depleted. A user may change parameter values to redefine how part inventory levels are displayed. One objective of this functionality is to enable a user to configure the shortage parts graphical user interface to display parts that require the most immediate attention first. “Critical” and “shortage” parts that may be depleted can be monitored and analyzed throughout the day. In a general sense, critical parts are produced when a parts balance on hand day value drops below a certain predefined value (e.g., 2.6 days capacity—other predefined values may be utilized). Critical and shortage parts are monitored in an effort to avoid depletion at the manufacturer plant(s). When an inventory level for a critical part is created, that part may be highlighted as critical or have an associated “CRIT” identifier. In a general sense, shortage parts are parts that require a new promise from a supplier and are typically determined by the value specified in the balance on hand days high parameter. An initial promise status is unanswered and will display “ANS” (answered) or “N/M” (nightman) after a supplier has successfully entered a promise. A promise status of “CRIT” may be configured to override all other promise statuses and display as such until a supplier enters a promise for the part in question.

As represented by arrow 24, a user is provided with functionality for viewing, adding, changing, deleting, etc., promises and remarks. A promises/remarks page provides a user with real-time inventory position and promise data for a specific part/supplier combination. The addition of new promises, multiple promises, or remarks and updates or deletions of existing promises or remarks is also supported. An example graphical user interface for processing supplier promises and remarks is illustrated and described in greater detail below.

As represented by arrow 26, a user is provided with functionality for viewing, changing, adding, deleting, etc., packaging information with regard to promised inventory. In accordance with a preferred embodiment of the present invention, a packaging summary screen lists parts for a supplier by status of the packaging specification. Packaging specification status may be determined by a confirm code for returnable or expendable packaging. Preferably, users can inquire by “all”, “unconfirmed”, and “confirmed” packaging status and/or by individual confirm codes to confirm that shipments are being made. In addition, the packaging summary screen may detail a supplier's parts by confirm status and list each manufacturer plant that uses a particular part. The screen may display part status by plant. An example GUI for presenting and managing inventory packaging information is illustrated and described in greater detail below.

As represented by arrow 28, a user is provided with functionality for reconciling inventory data. In accordance with a preferred embodiment of the present invention, a graphical user interface is provided for capturing and displaying cumulative ship and receipt data by reconciliation status code for a particular supplier. This feature of the present invention may facilitate a communication process between a supplier and a manufacturing plant such that cumulative ship and receipt records can be reconciled. A goal of this cumulative reconciliation aspect of the present invention is to confirm that a supplier's cumulative ship records are in agreement with the cumulative receipt and in-transit records at their customer plants. An example graphical user interface illustrating this and other reconciliation functionality provided in accordance with the present invention is illustrated and described in greater detail below.

As represented by arrow 30, a user is provided with functionality to view, add, change, delete, etc., supplier contacts with a manufacturer and/or various manufacturing plants. In accordance with a preferred embodiment of the present invention, an interactive contact list summary is provided enabling a user to input and modify contact information (name, address, telephone number, shipping address, etc.) for the one or more manufacturing plants the supplier supplies parts to.

As referenced by arrow 34, a user is provided with Advanced Ship Notices functionality for reviewing (ASNs). The suppliers, before they ship the parts to the plants, send the advanced shipping notices to the manufacturer, indicating that they are planning to ship the part, with quantity and when they will arrive and where they will arrive information. This screen will list all the ASNs the supplier is supplying to various manufacturer plants. A particular ASN can be selected from this listing to further review the details of the ASN. Suppliers can look at the history of ASN transactions, and formatted ASN record information as well as unformatted (as-is) ASNs. Ability to view the EDI transactions record for a given ASN is also possible using this screen.

As represented by arrow 36, a user is provided with functionality for viewing transaction history. In a preferred embodiment, transaction history information is provided in a graphical user interface and displays all inventory transactions and corresponding transaction detail for a given part number. Transaction detail may include relevant dates and quantities, along with cumulative receipt quantity from a supplier as of a relevant roll-out date. Filter functionality may be provided enabling a user to define search criteria used to create the list of transactions to be displayed. Preferably, a user may view data for all supplier codes, plant codes, part numbers, etc., per the user's security profile. Additionally, if a user is viewing the transaction history page from another page provided in accordance with the present invention, the part number and corresponding relationships in session will automatically display on the transaction history page.

As represented by arrow 40, a user may be provided with functionality for viewing release information. A release detail interface may display fabricated material (FAB) and RAW material authorization information for a particular part/supplier relationship and strike protection details when applicable. Strike protection details define special inventory levels that may be required during union negotiations as a precautionary measure. The strike protection detail includes information on quantities of parts required during the negotiation time frame.

A release recap screen may display corresponding dates and cumulative quantities for previous releases. Data may be aligned by ship/delivery date of the latest release. Functionality may additionally be provided enabling a user to make release to release trend comparisons. A supplier release screen may display a supplier release information that was sent to the supplier in an electronic release. Supplier can also view the segments of part releases sent to the manufacturer against agreed upon requirements. This feature may be utilized to verify the current or future cumulative requirement for a particular part.

As represented by arrow 42, a user may be provided with functionality to view an up-to-date calendar for each manufacturer plant, or each plant the supplier supplies to. The plant calendar will list and indicate the plant working days, holidays and planned shut down days. Preferably, the calendar will list five years, (two past years, current year and two future years). User can select a particular year and view the monthly listing for that year. This will enable suppliers to plan their production accordingly and send shipments to the plants accordingly.

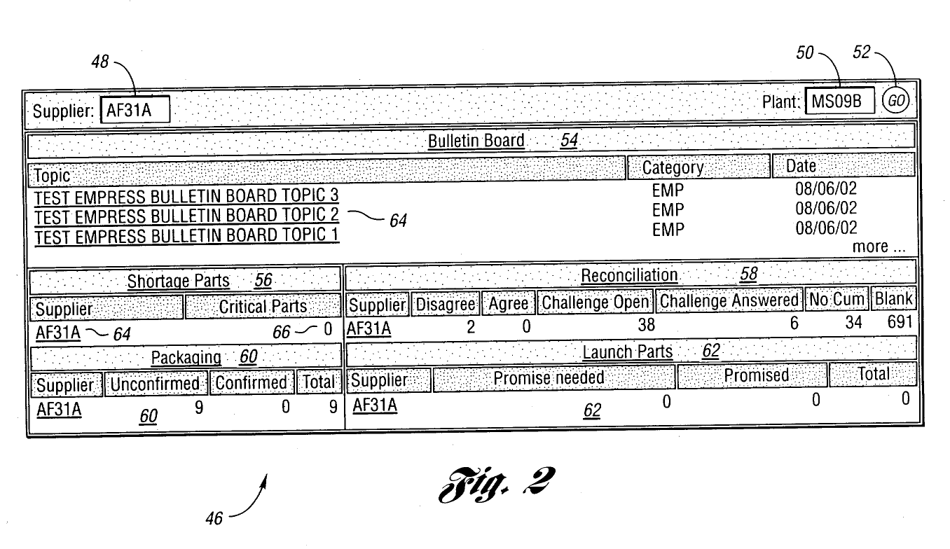

FIG. 2 illustrates an example “homepage” GUI 46 in accordance with a preferred embodiment of the present invention. Notably, the content or arrangement of data and functionality provided in GUI 46 may be modified, supplemented or otherwise adapted to best fit a particular implementation of the present invention. A user accessing GUI 46 inputs a supplier ID 48 and plant ID 50 into the corresponding data entry fields. Upon selecting the “Go” button 52, the bulletin board region 54, shortage parts region 56, reconciliation region 58, packaging region 60 and launch parts region 62 are populated with up-to-date information relating the particular supplier/plant relationship defined in fields 48 and 50.

Bulletin board region 54 may contain hyperlinks 64 to more detailed manufacturer bulletin board messages for distribution to a particular supplier, supplier group, or the entire supply base. Shortage parts region 56 provides a hyperlinks 66 to inventory information for all parts supplier 48 is currently supplying to plant 50. An identifier 66 indicates whether a part shortage (e.g., shortage, critical shortage, etc.) exists. Reconciliation region 58, packaging region 60 and launch parts region 62 each contain a corresponding status summary corresponding to supplier 48.

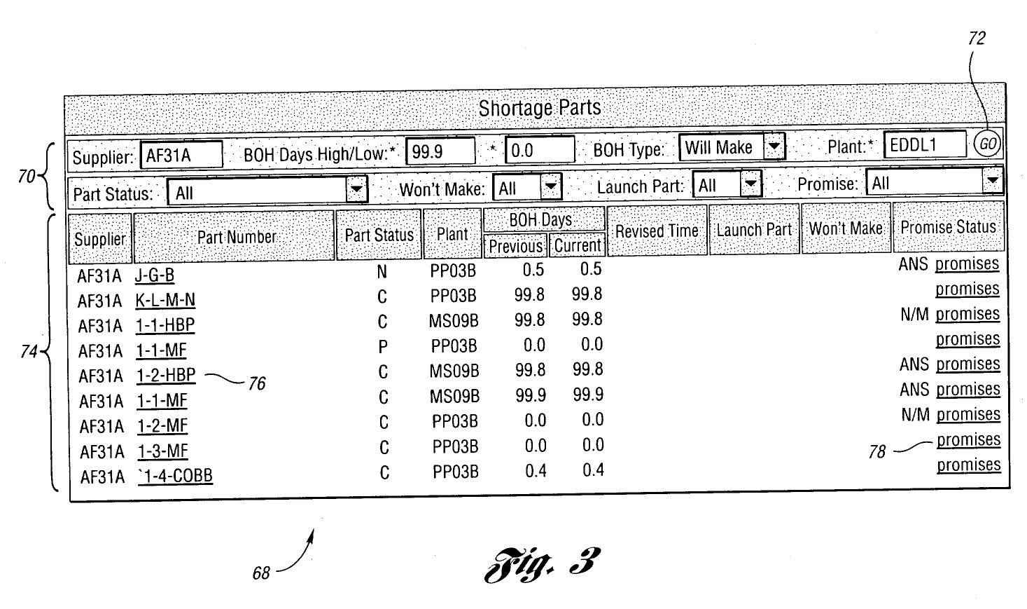

FIG. 3 illustrates an example “shortage parts” GUI 68 in accordance with a preferred embodiment of the present invention. Notably, the content or arrangement of data and functionality provided in GUI 68 may be modified, supplemented or otherwise adapted to best fit a particular implementation of the present invention. A user accessing GUI 68 inputs data in header region 70 including but not limited to supplier ID, balance-on-hand (“BOH”) high and low values, BOH type (e.g., will make, loose, arrived, etc.), plant ID, part status (e.g., New, Prototype, Current model, Service, etc.) won't make (i.e., inventory for which an in-transit quantity exists that will not protect run-out time), launch part (i.e., part has a “new” status), and promise (e.g., unanswered, answered, nightman, critical, etc.). Upon selecting the “Go” button 72, region 74 is populated with up-to-date manufacturer inventory information and inventory status indications for each part or material the supplier (i.e., AF31A) supplies to the manufacturer's plant(s). Information is presented in region 74 in a manner dictated by criteria selection within region 70.

Upon selecting a hyperlink 76 associated with a particular part number, a user is presented with more detailed manufacturer inventory information corresponding to the selected part. An example inventory GUI is illustrated and described in greater detail below. Similarly, upon selecting a hyperlink 78 associated with a particular part number promise, a user is presented with more detailed promise information corresponding to the selected part. An example part promise GUI is illustrated and described in greater detail below.

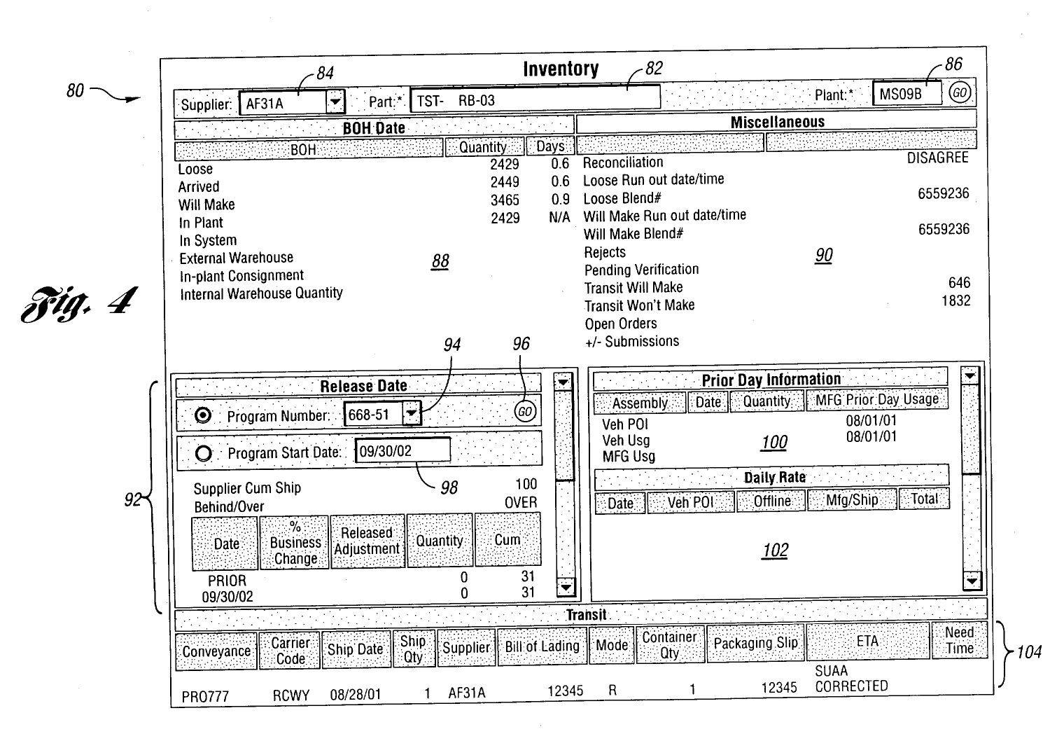

FIG. 4 illustrates an example “inventory” GUI 80 in accordance with a preferred embodiment of the present invention. Notably, the content or arrangement of data and functionality provided in GUI 80 may be modified, supplemented or otherwise adapted to best fit a particular implementation of the present invention. GUI 80 displays real-time manufacturer inventory information corresponding to a particular part or material 82 supplied by a particular supplier 84 to a particular plant 86. Information in fields 82-86 may be manually input by a user or automatically input upon selecting a prior hyperlink during the same session. Balance-on-hand information 88 includes indicators for a quantity and days-until-delivered for each of several categories of parts (e.g., loose, arrived, will make, etc.). Miscellaneous information 90 includes a variety of indicators and information relating to the part at issue, including a reconciliation status indicator (i.e., DISAGREE), etc. The reconciliation aspect of the present invention is described in greater detail below. Release data region 92 enables a user to access current and historical release data for the designated part by program or start date. Release history information will be displayed to the user in descending order by program date within a program number drop-down menu 94. Release information may be provided for categories including but not limited to daily ship releases, weekly planning releases, etc. Upon selecting a desired program, the user may then select the “Go” button 96 and view release data corresponding to that program. Utilizing the program start date field 98, a user can view historical release information. Prior day information region 100 displays prior day usage for the designated part. Daily rate information region presents daily requirements or point-of-installation daily rates for the designated part. Transit information region 104 displays transit details for the designated part on conveyances that have not been received.

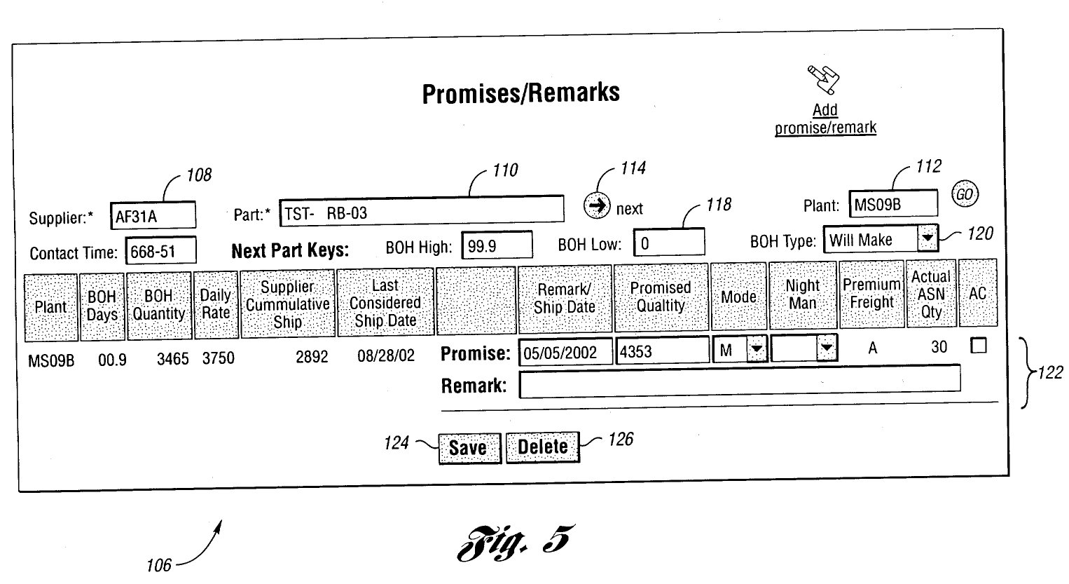

FIG. 5 illustrates an example “promises/remarks” GUI 106 in accordance with a preferred embodiment of the present invention. Notably, the content or arrangement of data and functionality provided in GUI 106 may be modified, supplemented or otherwise adapted to best fit a particular implementation of the present invention. The promises/remarks GUI 106 provides a user with the real-time inventory position and promise data for a specific part/supplier combination. Addition of new promises, multiple promises, remarks, updates, deletions of existing promises, etc., is also supported.

A user accessing GUI 106 inputs a supplier code 108, a part number 110 and a plant ID 112. In the event that an inquiry is under a specific plant code, inventory and promise data for the specific plant will be displayed. If an inquiry is under a plant group, inventory and promise data for each plant within the group will be displayed. A next button 114 is provided for scrolling through part numbers, as defined in the “Next Part Keys” fields 116, 118 and 120. The “BOH Type” selection 120 controls which values display for each plant in the “BOH Days” and “BOH Quantity” fields. For example, if the user selects “Loose” in the drop down menu 120, then the “BOH Loose Days” and the “BOH Loose Quantity” values will be displayed.

Provided there is no matching ASN for the particular part/supplier/plant combination, an existing promise may be updated as shown in region 122. If no matching ASN exists, a user may update the “Remark/Ship Date”, “Promise Quantity”, “Mode”, “Nightman”, and “Remark” fields. A promise may be added by entering values in the appropriate fields, selecting the “AC” box and clicking the “Save” button 124. A remark may be added by entering values in the “Remark/Ship Date” field, selecting the “AC” box and clicking the “Save” button 124. Similarly, promises and remarks may be deleted utilizing the “Delete” button 126.

The “promise/remarks” aspect of the present invention enables a supplier to proactively promise goods to the manufacturer on an as-needed basis without requiring that the manufacturer initiate continuing purchase orders or requisitions. Of course, an initial supply relationship is typically established between a manufacturer and a supplier before using the present invention. Such a formal arrangement, however, is not required.

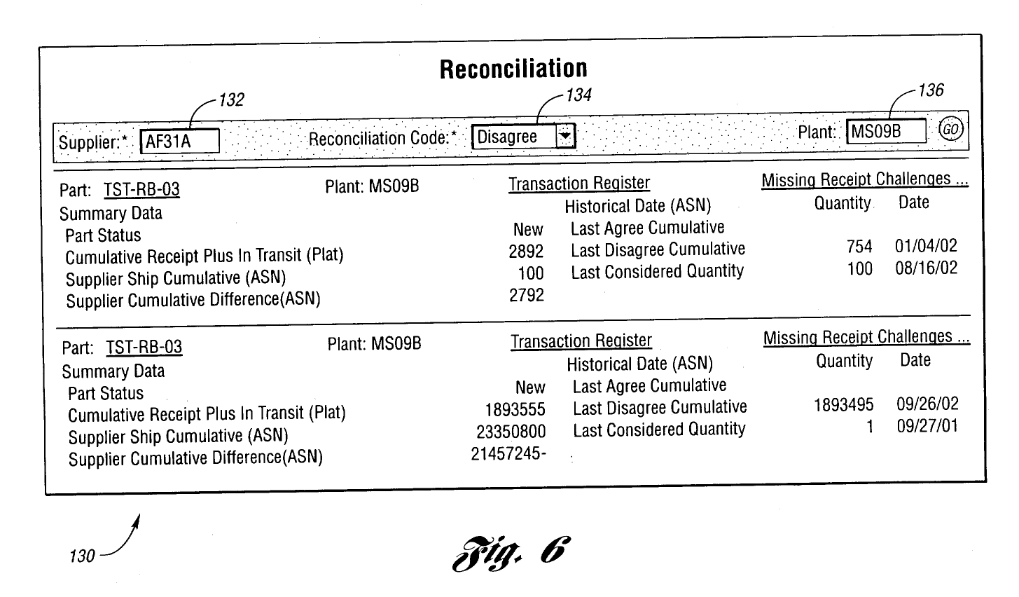

FIG. 6 illustrates an example “Reconciliation” GUI 130 in accordance with a preferred embodiment of the present invention. Notably, the content or arrangement of data and functionality provided in GUI 130 may be modified, implemented, or otherwise adapted to best fit a particular implementation of the present invention. The reconciliation GUI 130 provides indicators for cumulative ship and receipt data by user-defined supplier 132 reconciliation status code 134 and plant 136.

This aspect of the present invention may facilitate communication between a supplier and a plant or centralized follow-up organization whereby cumulative ship and receipt records are reconciled. A goal of this aspect of the present invention is to ensure that the cumulative ship records at a supplier location match the cumulative receipt and in-transit records at their customer plants.

Data indicated in FIG. 6 may be used to analyze cumulative shop and receipt data for a specified supplier to its plant customers. Challenges to specific inventory transactions or missing inventory transactions may be created and submitted to the manufacturer for review and resolution when the cumulative ship record for a supplier is not in agreement with the cumulative receipt and in-transit record for a customer plant. Reconciliation status may be determined for a part by a match of the cumulative receipt and in-transit record for a customer plant to the cumulative ship quantity entered by a supplier on the Advanced Ship Notice (ASN). Valid reconciliation codes or indicators 134 may include: Disagree, Agree, Blank (no shipments received since cumulative roll-back), Challenge, and No Cums (cumulative data not included on ASN).

In one embodiment, cumulative reconciliation is not performed for manual ASNs or for suspended ASNs that have been corrected. A parts reconciliation status will be updated upon generation of the next electronic non-suspended ASN.

Preferably, all parts with a reconciliation code of “Disagree” are analyzed and then challenged upon identification of cause of the cumulative discrepancy and determination of the necessary action or correction required. Challenges are automatically forwarded to an appropriate manufacturer inventory manager for prompt resolution. Effective use of this aspect of the present invention will promote record integrity between a supplier and their customers.

The Reconciliation GUI 130 may be displayed in conjunction with a Transaction Register (not shown) as a split-screen for the designated part. The Transaction Register displays as a separate frame or window in the lower portion of the page and allows the user to scroll within or resize for dual analysis of transaction records and inventory cumulative ship and receipt data.

The display of parts may be segregated by the selected reconciliation code. The default display is preferably all parts with a code of “Disagree” for a given supplier and the plant or plant group code selected. Any of the other valid reconciliation codes may be selected from the reconciliation code drop-down menu 134 to filter the display of parts by code.

An accompanying Transaction Register frame (not shown) may be used in conjunction with the Reconciliation frame 130 when analyzing inventory and cumulative ship and receipt records. In this embodiment, the first part listed in the Reconciliation page will automatically display in the Transaction Register. The user may select additional parts from the Reconciliation page for display in the Transaction Register by selecting a Transaction Register link for the desired part number/plant combination.

Table 1, below, contains example Reconciliation codes and corresponding descriptions.

TABLE 1

| CODE | DESCRIPTION |
|---|---|
| Agree | The cumulative ship record for a supplier is in |
| | agreement with the cumulative receipt and in- |
| | transit record for a customer plant. |
| Disagree | The cumulative ship record for a supplier is |
| | NOT in agreement with the cumulative receipt |
| | and in-transit record for a customer plant. |
| Blank | No shipments since cumulative roll-back, or |
| | last receipt was a manual ASN. |
| Challenge | A challenge has been created by a follow-up |
| | analyst or supplier. |
| No Cums | Cumulative ship quantity not included on |
| | supplier ASN. |

An existing challenge may be inquired upon by selecting the “Missing Receipt Challenges” link 136 or by selecting the specific “Challenge Transaction” from the Transaction Register (not shown) for parts with a reconciliation code of “Challenge”.

Challenge types include “missing receipt”, “challenge receipt”, “challenge return” and “challenge discrepancy”.

A supplier may define a challenge for a particular part via data input fields (not shown) including “reason”, “ship date”, “quantity”, “supplier remarks”, etc. Challenges may be updated after submission.

Challenges to cumulative ship and receipt records may be added to parts in any of the valid reconciliation statuses. Multiple challenges may also be added to parts that currently have an existing challenge. Adding challenges generally applies to parts in a “Disagree” status. A challenge can be created and answered as a supplier and plant or centralized follow-up analyst communicate to reconcile plant receipt and supplier ship cumulative records.

A “Missing Receipt Challenge” may be created when it is determined that a shipment from a supplier does not exist in the given plants records. Data pertaining to the actual shipment such as packing slip and conveyance number can be included in the “Supplier Remarks” field in addition to the mandatory fields (ship date, quantity, supplier remarks).

Challenges of receipts, returns or discrepancies are created by selecting the specific transaction from the Transaction Register (not shown). A user may select (click) on the specific transaction to be challenged in the Transaction Register to open the window where the challenge is created. Once selected, the window will open primed with the relevant data from the specific transaction selected.

Upon user confirmation, the window containing the newly created challenge will display and the reconciliation code will change from “Disagree” to “Challenge”. The updated reconciliation status will be reflected on all pages (Reconciliation and Home Page).

The Transaction Register page (not shown) displays all inventory transactions and corresponding transaction detail for a specified part number. The transaction detail includes relevant dates and quantities along with the cumulative receipt quantity from a supplier since the model year rollover date. Various filters in the upper portion of the page allow the user to define search criteria used to create the list of transactions to be displayed.

The Transaction Register page exists as a single page that can be reached from the menu tree as well as a dual (split-screen) page on the inventory and Reconciliation pages. If inquired upon as a single page, the part number and relationships in session will display. If inquired upon via the Inventory or Reconciliation page, the part number and relationships displayed in the Transaction Register will coincide with the part number successfully inquired upon in the upper portion of the Inventory or Reconciliation page.

A user may view data for all supplier codes, plant codes, and part numbers. Data input fields may include Supplier Code, Part Number, Plant Code, and Transaction (default “ALL”). Different values may be entered at anytime if so desired. If the user is routing to the Transaction Register from another page in the application, the part number and relationships in session will automatically display.

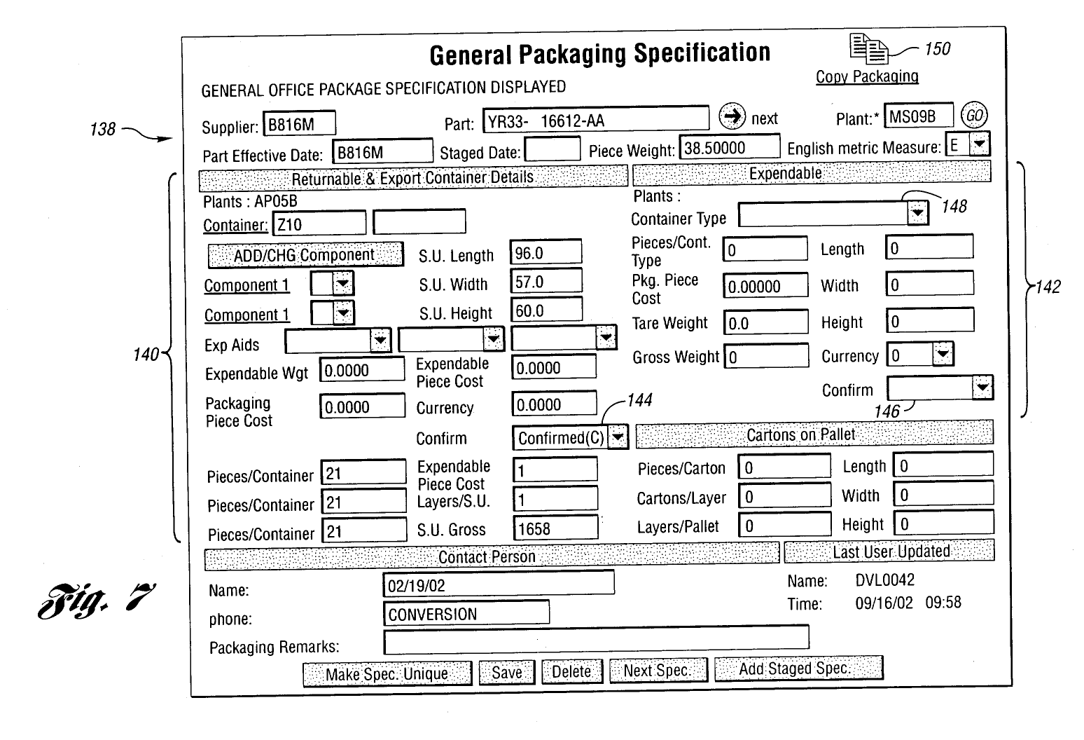

FIG. 7 illustrates an example “Packaging Specification” GUI 138 in accordance with a preferred embodiment of the present invention. Notably, the content or arrangement of data and functionality provided in GUI 138 may be modified, implemented, or otherwise adapted to best fit a particular implementation of the present invention. The reconciliation GUI 138 allows entry and update of purchase part packaging information for a part/supplier/plant(s) relationship. A general specification allows the entry of packaging information one time for a part/supplier for all plants that supplier provides that part. Unique specifications may be used when part packaging is specific to a particular plant and different from the general specification making it unique in concept.

Part packaging is input as either returnable 140 or expendable 142 and the screen is divided into those two categories. Each side of the packaging specification has a confirm code field 144 and 146, respectively, for indicating whether promised supplier shipments have been made. Plants are listed above each side depending upon which side of the packaging specification is effective for that plant. This is also displayed on the packaging screen by effective date.

Expendable packaging 148 include COP (Cartons on Pallet), BAG (Bag), PTP (Pallet Tray Pack), BDL (Bundle), CTN (Carton), FPB (Flipside Pallet Box), LSE (Loose), TCR (Timber Crate), PLT (Pallet), TCP (Timber Crate Integral Pallet), and PBX (Pallet Box).

A “Copy Packaging” button 150 enables a user to copy part packaging information between parts for a given supplier. The “target” of the packaging copy is a blank packaging specification.

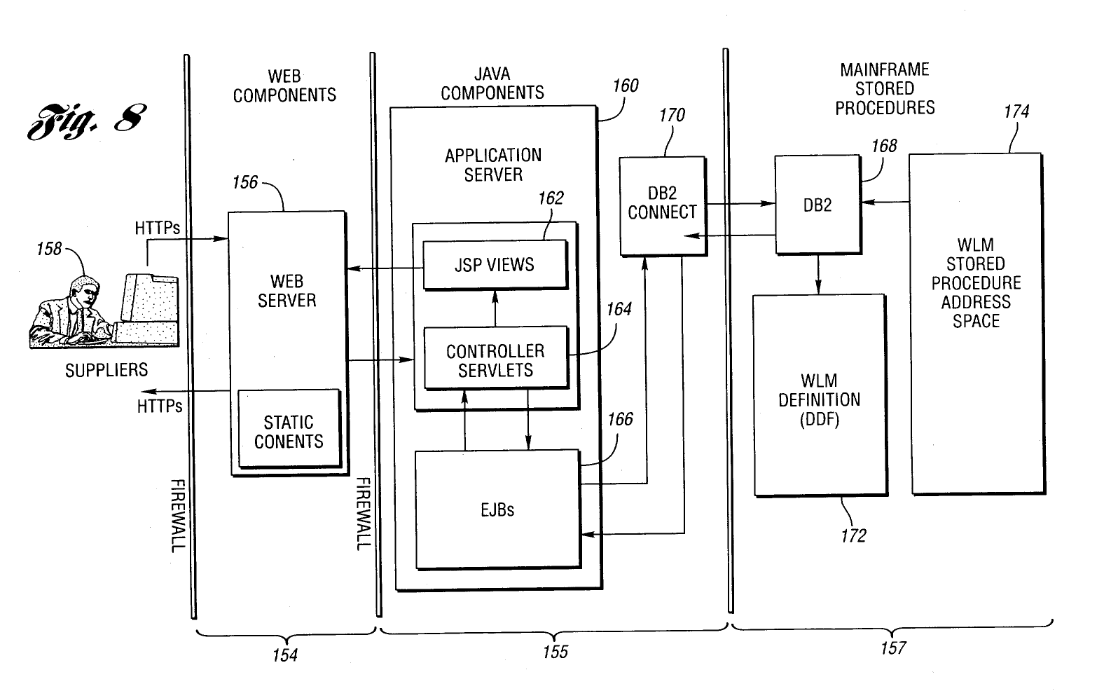

FIG. 8 illustrates an example computer system architecture 152 for implementing aspects of the present invention. Notably, the content or arrangement of components and configurations illustrated in FIG. 8 may be modified or adapted to best fit a particular implementation of the present invention. Computer system architecture 152 includes web components 154 (e.g., web servers) serving users (e.g., suppliers 158) as an interface to application server 160 among Java components 155. Application server 160 includes Java server pages, controller servlets 164 and Enterprise JavaBeans 166. Enterprise JavaBeans 166 interface with mainframe components 157. Mainframe components 157 include DB2 universal relational database(s) 168 accessible via DB2 connector 170. DB2 database(s) operably interfaces with IBM workload manager (WLM) definitions (DDF enclaves) 172 and WLM stored procedure address space 174. In accordance with a preferred embodiment of the present invention, data for populating the various graphical user interfaces illustrated and/or described above is stored within database(s) 168 and is populated, updated and maintained by the manufacturer.

While the best mode for carrying out the invention has been described in detail, those familiar with the art to which this invention relates will recognize various alternative designs and embodiments for practicing the invention as defined by the following claims.

What is claimed:

1. A computer system enabling suppliers to monitor and manage real-time manufacturer inventory levels for supplied goods, the computer system comprising a client-server architecture in operable communication with at least one database of real-time manufacturer inventory information for supplied goods wherein at least one computer server is operably configured to:
receive input defining a supplier and a manufacturer plant to which the supplier supplies goods;
present output including a listing of at least one good the supplier supplies to the manufacturer plant and, for each good listed, the current manufacturer balance-on-hand for that good, the number of days before the manufacturer balance-on-hand will be depleted, and an indicator if the current manufacturer balance-on-hand is below a predefined level; and
receive input from the supplier promising to supply at least one good having a current manufacturer balance-on-hand below the predefined level.

2. The system of claim 1 wherein input from the supplier promising to supply the at least one good is received without providing output to the supplier including a manufacturer's request that the supplier supply the at least one good.

3. The system of claim 1 wherein goods include parts, assemblies or raw materials.

4. The system of claim 1 wherein a second indicator identifies any listed goods having a manufacturer balance-on-hand level below a second predefined level.

5. The system of claim 1 wherein the at least one computer server is additionally configured to output, for each good listed, an indication as to whether supplier shipped an in-transit quantities for the good reconciles with the manufacturer's received quantity for the good.

6. The system of claim 5 wherein the at least one computer server is additionally configured to receive input challenging the manufacturer's received quantity for the good.

7. The system of claim 1 wherein the at least one computer server is additionally configured to present output including a bulletin board having one or more manufacturer messages for the supplier.

8. The system of claim 1 wherein the at least one computer server is additionally configured to receive input defining packaging specification information for goods the supplier supplies to the manufacturer plant.

9. The system of claim 8 wherein the packaging specification information includes an indication as to whether shipments has been confirmed by the supplier.

10. The system of claim 1 wherein the at least one computer server is additionally configured to present output including a transaction register displaying historical inventory transaction information for a specified good.

11. The system of claim 1 wherein the client-server architecture is implemented on the Internet.

12. A computer-implemented method enabling suppliers to monitor and manage real-time manufacturer inventory levels for supplied goods, the method implemented in a client-server architecture in operable communication with at least one database of real-time manufacturer inventory information for supplied goods, the method comprising:
receiving input at a client computer defining a supplier and a manufacturer plant to which the supplier supplies goods;
displaying at the client computer a listing of at least one good the supplier supplies to the manufacturer plant and, for each good listed, the current manufacturer balance-on-hand for that good, the number of days before the manufacturer balance-on-hand will be depleted, and an indicator if the current manufacturer balance-on-hand is below a predefined level; and
receiving input at the client computer defining a promise to supply at least one good having a current manufacturer balance-on-hand below the predefined level.

13. The method of claim 12 wherein the promise to supply the at least one good is received without providing the supplier with a manufacturer's request that the supplier supply the at least one good.

14. The method of claim 12 wherein goods include parts, assemblies or raw materials.

15. The method of claim 12 additionally comprising shipping the promised goods from the supplier to the manufacturer.

16. The method of claim 12 additionally comprising displaying an indicator at the client computer indicating any listed goods that have a manufacturer balance-on-hand level below a second predefined level.

17. The method of claim 12 additionally comprising displaying an indicator at the client computer indicating whether supplier shipped and in-transit quantities for the good reconcile with manufacturer received quantity for the good.

18. The method of claim 17 additionally comprising receiving input at the client computer challenging the manufacturer received quantity for the good.

19. The method of claim 12 additionally comprising displaying at the client computer a bulletin board having one or more manufacturer messages for the supplier.

20. The method of claim 12 additionally comprising receiving input at the client computer defining packaging specification information for goods the supplier supplies to the manufacturer plant.

21. The method of claim 20 wherein the packaging specification information includes an indication as to whether a shipment has been confirmed by the supplier.

22. The method of claim 12 additionally comprising displaying at the client computer a transaction register presenting historical inventory transaction information for a specified good.

23. The method of claim 12 wherein the method is implemented over the Internet.
